(19) United States
(12) Patent Application Publication
(10) Pub. No.: US 2015/0232774 A1
(43) Pub. Date: Aug. 20, 2015

(54) FUEL ADDITIVE FOR DIESEL ENGINES

(71) Applicant: AFTON CHEMICAL CORPORATION, Richmond, VA (US)

(72) Inventors: Xinggao FANG, Midlothian, VA (US); Scott D. SCHWAB, Richmond, VA (US)

(73) Assignee: AFTON CHEMICAL CORPORATION, Richmond, VA (US)

(21) Appl. No.: 14/184,188

(22) Filed: Feb. 19, 2014

(51) Int. Cl. C10L 1/18; F02M 25/00; F02B 47/04

(52) U.S. Cl. CPC C10L 1/18; F02B 47/04; F02M 25/00

(57) ABSTRACT

In accordance with the disclosure, exemplary embodiments provide a method for improving injector performance, a method for restoring power to a diesel fuel injected engine, and a method of operating a fuel injected diesel engine. The method includes combining a fuel with a reaction product derived from (i) a hydrocarbyl substituted dicarboxylic acid or anhydride, wherein the hydrocarbyl substituent has a number average molecular weight ranging from about 600 to about 800 and (ii) a polyamine includes a compound of the formula H₂N—((CHR¹—(CH₂)ₙ—NH)ₘ—H, wherein R¹ is hydrogen, n is 1 and m is 4, wherein a molar ratio of (i) reacted with (ii) ranges from about 1.3:1 to about 1.6:1. The reaction product, as made, contains no more than 3.0 wt. % unreacted polyamine in the reaction product based on active material in the reaction product.

### TECHNICAL FIELD

The disclosure is directed to fuel additives and to additive and additive concentrates that include the additive that are useful for improving the performance of fuel injected engines. In particular the disclosure is directed to a fuel additive that is effective to enhance the performance of fuel injectors for internal combustion engines.

### BACKGROUND AND SUMMARY

It has long been desired to maximize fuel economy, power and driveability in vehicles while enhancing acceleration, reducing emissions, and preventing hesitation. New engine technologies require more effective additives to keep the engines running smoothly. Additives are required to keep the fuel injectors clean or clean up fouled injectors for spark and compression type engines. Engines are also being designed to run on alternative renewable fuels. Such renewal fuels may include fatty acid esters and other biofuels which are known to cause deposit formation in the fuel supply systems for the engines. Such deposits may reduce or completely bock fuel flow, leading to undesirable engine performance.

Also, low sulfur fuels and ultra low sulfur fuels are now common in the marketplace for internal combustion engines. A “low sulfur” fuel means a fuel having a sulfur content of 50 ppm by weight or less based on a total weight of the fuel. An “ultra low sulfur” fuel means a fuel having a sulfur content of 15 ppm by weight or less based on a total weight of the fuel. Low sulfur fuels tend to form more deposits in engines than conventional fuels, for example, because of the need for additional friction modifiers and/or corrosion inhibitors in the low sulfur fuels.

Succinimide dispersants are well known fuel additives for cleaning up deposit in fuel delivery systems such as injectors and filters. There has been a tremendous amount of effort devoted to finding succinimide dispersants that can provide superior detergency without scarifying other fuel properties. For example, one problem with conventional succinimide detergents is that such additives may detrimentally affect the demulsibility of the fuel composition. Accordingly, there continues to be a need for fuel additives that are effective in cleaning up fuel injector or supply systems and maintaining the fuel injectors operating at their peak efficiency without adversely affecting the demulsibility of the fuel.

In accordance with the disclosure, exemplary embodiments provide a method for improving injector performance, a method for restoring power to a diesel fuel injected engine, a method of operating a fuel injected diesel engine, and a method of improving the demulsibility of a diesel fuel. The method includes combining a fuel with a reaction product derived from (i) a hydrocarbyl substituted dicarboxylic acid or anhydride, wherein the hydrocarbyl substituent has a number average molecular weight ranging from about 600 to about 800 and (ii) a polyamine including a compound of the formula H₂N—((CHR¹—(CH₂)ₙ—NH)ₘ—H, wherein R¹ is hydrogen, n is 1 and m is 4, wherein a molar ratio of (i) reacted with (ii) ranges from about 1.3:1 to about 1.6:1. The reaction product, as made, contains no more than 3.0 wt. % unreacted polyamine in the reaction product based on active material in the reaction product.

One embodiment of the disclosure provides a method of operating a fuel injected diesel engine. The method includes combusting in the engine a fuel composition that includes a major amount of fuel and from about 25 to about 300 ppm by weight based on a total weight of the fuel of an additive that is a reaction product derived from (i) a hydrocarbyl substituted dicarboxylic acid or anhydride, wherein the hydrocarbyl substituent has a number average molecular weight ranging from about 600 to about 800 and (ii) tetraethylene pentamine (TEPA). A molar ratio of (i) reacted with (ii) ranges from about 1.3:1 to about 1.6:1. The reaction product, as made, contains no more than 3.0 wt. % unreacted polyamine in the reaction product based on active material in the reaction product.

Another embodiment of the disclosure provides a method of restoring power to a diesel fuel injected engine after an engine dirty-up phase. The method includes combusting in the engine a diesel fuel composition containing a major amount of fuel and from about 25 to about 300 ppm by weight based on a total weight of the fuel composition of a reaction product derived from (i) a hydrocarbyl substituted dicarboxylic acid or anhydride, wherein the hydrocarbyl substituent has a number average molecular weight ranging from about 600 to about 800 and (ii) a polyamine including a compound of the formula H₂N—((CHR¹—(CH₂)ₙ—NH)ₘ—H, wherein R¹ is hydrogen, n is 1 and m is 4. A molar ratio of (i) reacted with (ii) ranges from about 1.3:1 to about 1.6:1. The reaction product, as made, contains no more than 3.0 wt. % unreacted polyamine in the reaction product based on active material in the reaction product.

Power restoration is measured by the following formula:

Percent Power recovery=(DU−CU)/DU×100

wherein DU is a percent power loss at the end of a dirty-up phase without the reaction product, CU is the percent power loss at the end of a clean-up phase with the reaction product, and said power restoration is greater than 30%.

Yet another embodiment of the disclosure provides method of improving the demulsibility of an additive containing diesel fuel. The method includes combining a major amount of diesel fuel with from about 25 to about 300 ppm by weight based on a total weight of the fuel of a reaction product derived from (i) a hydrocarbyl substituted dicarboxylic acid or anhydride, wherein the hydrocarbyl substituent has a number average molecular weight ranging from about 600 to about 800 and (ii) a polyamine including a compound of the formula H₂N—((CHR¹—(CH₂)ₙ—NH)ₘ—H, wherein R¹ is hydrogen, n is 1 and m is 4. A molar ratio of (i) reacted with (ii) ranges from about 1.3:1 to about 1.6:1. The reaction product, as made, contains no more than 3.0 wt. % unreacted polyamine in the reaction product based on active material in the reaction product.

A surprising advantage of the reaction product of the present disclosure is that a reaction product made with a hydrocarbyl substituted dicarboxylic acid or anhydride, wherein the hydrocarbyl substituent has a number average molecular weight ranging from about 600 to about 800 and a narrow molar ratio of polyamine is surprisingly and unexpectedly superior in power recovery and demulsibility compared to a conventional detergent made with a hydrocarbyl substituted dicarboxylic acid or anhydride having a number average molecular weight in the range of 300 to 600 or 900 to 1800 and a lower or higher molar ratio of hydrocarbyl substituted dicarboxylic acid or anhydride to amine.

Additional embodiments and advantages of the disclosure will be set forth in part in the detailed description which follows, and/or can be learned by practice of the disclosure. It is to be understood that both the foregoing general description and the following detailed description are exemplary and explanatory only and are not restrictive of the disclosure, as claimed.

### DETAILED DESCRIPTION OF EXEMPLARY EMBODIMENTS

The reaction product described above may be used in a minor amount in a major amount of fuel and may be added to the fuel directly or added as a component of an additive concentrate to the fuel.

As used herein, the term “hydrocarbyl group” or “hydrocarbyl” is used in its ordinary sense, which is well-known to those skilled in the art. Specifically, it refers to a group having a carbon atom directly attached to the remainder of a molecule and having a predominantly hydrocarbon character. Examples of hydrocarbyl groups include:
(1) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form an alicyclic radical);
(2) substituted hydrocarbon substituents, that is, substituents containing non-hydrocarbon groups which, in the context of the description herein, do not alter the predominantly hydrocarbon substituent (e.g., halo (especially chloro and fluoro), hydroxy, alkoxy, mercapto, alkylmercapto, nitro, nitroso, amino, alkylamino, and sulfoxy);
(3) hetero-substituents, that is, substituents which, while having a predominantly hydrocarbon character, in the context of this description, contain other than carbon in a ring or chain otherwise composed of carbon atoms. Hetero-atoms include sulfur, oxygen, nitrogen, and encompass substituents such as carbonyl, amido, imido, pyridyl, furyl, thienyl, ureyl, and imidazolyl. In general, no more than two, or as a further example, no more than one, non-hydrocarbon substituent will be present for every ten carbon atoms in the hydrocarbyl group; in some embodiments, there will be no non-hydrocarbon substituent in the hydrocarbyl group.

As used herein, the term “major amount” is understood to mean an amount greater than or equal to 50 wt. %, for example from about 80 to about 98 wt. % relative to the total weight of the composition. Moreover, as used herein, the term “minor amount” is understood to mean an amount less than 50 wt. % relative to the total weight of the composition.

As used herein the term “ultra-low sulfur” means fuels having a sulfur content of 15 ppm by weight or less.

The additive composition, described herein, is a reaction product of (i) a hydrocarbyl substituted dicarboxylic acid or anhydride having a number average molecular weight ranging from about 600 to about 800 and (ii) a polyamine of the formula H₂N—((CHR¹—(CH₂)ₙ—NH)ₘ—H, wherein R¹ is hydrogen, n is 1 and m is 4, wherein a molar ratio of (i) reacted with (ii) ranges from about 1.3:1 to about 1.6:1.

Component (i) may be a hydrocarbyl carbonyl compound of the formula

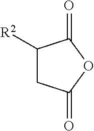

wherein R² is a hydrocarbyl group derived from a polyolefin. In some aspects, the hydrocarbyl carbonyl compound may be a polyalkylene succinic anhydride reactant wherein R² is a hydrocarbyl moiety, such as for example, a polyalkenyl radical having a number average molecular weight of from about 600 to about 800. For example, the number average molecular weight of R² may range from about 700 to about 800, such as about 750, as measured by GPC. Unless indicated otherwise, molecular weights in the present specification are number average molecular weights.

The R² hydrocarbyl moiety may comprise one or more polymer units chosen from linear or branched alkenyl units. In some aspects, the alkenyl units may have from about 2 to about 10 carbon atoms. For example, the polyalkenyl radical may comprise one or more linear or branched polymer units chosen from ethylene radicals, propylene radicals, butylene radicals, pentene radicals, hexene radicals, octene radicals and decene radicals. In some aspects, the R² polyalkenyl radical may be in the form of, for example, a homopolymer, copolymer or terpolymer. In one aspect, the polyalkenyl radical is isobutylene. For example, the polyalkenyl radical may be a homopolymer of polyisobutylene comprising from about 10 to about 60 isobutylene groups, such as from about 20 to about 30 isobutylene groups. The polyalkenyl compounds used to form the R² polyalkenyl radicals may be formed by any suitable methods, such as by conventional catalytic oligomerization of alkenes.

In some aspects, high reactivity polyisobutenes having relatively high proportions of polymer molecules with a terminal vinylidene group may be used to form the R² group. In one example, at least about 60%, such as about 70% to about 90%, of the polyisobutenes comprise terminal olefinic double bonds. There is a general trend in the industry to convert to high reactivity polyisobutenes, and well known high reactivity polyisobutenes are disclosed, for example, in U.S. Pat. No. 4,152,499, the disclosure of which is herein incorporated by reference in its entirety.

In some embodiments, the molar ratio of the number of carbonyl groups to the number of hydrocarbyl moieties in the hydrocarbyl carbonyl compound may range from about 0.5:1 to about 5:1. In some aspects, approximately one mole of maleic anhydride may be reacted per mole of polyalkylene, such that the resulting polyalkenyl succinic anhydride has about 0.8 to about 1 succinic anhydride group per polyalkylene substituent. In other aspects, the molar ratio of succinic anhydride groups to alkylene groups may range from about 0.5 to about 3.5, such as from about 1 to about 1.1.

The hydrocarbyl carbonyl compounds may be made using any suitable method. Methods for forming hydrocarbyl carbonyl compounds are well known in the art. One example of a known method for forming a hydrocarbyl carbonyl compound comprises blending a polyolefin and maleic anhydride. The polyolefin and maleic anhydride reactants are heated to temperatures of, for example, about 150° C. to about 250° C., optionally, with the use of a catalyst, such as chlorine or peroxide. Another exemplary method of making the polyalkylene succinic anhydrides is described in U.S. Pat. No. 4,234,435, which is incorporated herein by reference in its entirety.

The polyamine reactant may include a compound of the formula H₂N—((CHR¹—(CH₂)ₙ—NH)ₘ—H, wherein R¹ is hydrogen, n is 1 and m is 4. In one embodiment, the polyamine is a ethylene polyamine. In another embodiment, the polyamine is tetraethylene pentamine. Polyamines having more nitrogen and alkylene groups less desirable for use due to higher halide residues and product consistency variations. The molar ratio of reactant (i) to (ii) in the reaction mixture for making the fuel additive may range from 1.3:1 to about 1.6:1. For example, a suitable molar ratio may range from about 1.3:1 to about 1.5:1. It is important that component (i) be in excess so that substantially all of component (ii) is reacted and the reaction product is substantially or totally devoid of unreacted component (ii). Unreacted component (ii) in the reaction product may result in deposits or sediment forming in the additive, poorer DW10 performance testing, unstable performance in an XUD-9 test, highly viscous material, deterioration during storage, and injector sticking. Accordingly, the molar ratio of (i) reacted with (ii) may be important to the proper performance of the additive component in a fuel composition. Residual amount of component (ii) in the reaction product may range from 0 to less than about 3.0 wt. % based on a total weight of active components in the reaction product. In one embodiment, the amount of residual amine in the reaction product may range from 0 to less than about 2.5 wt. %, and in another embodiment, from 0 to less than about 1.5 wt. % of the total active components in the reaction product.

Suitable reaction temperatures may range from about 70° C. to less than about 200° C. at atmospheric pressure. For example, reaction temperatures may range from about 110° C. to about 180° C. Any suitable reaction pressures may be used, such as, including subatmospheric pressures or superatmospheric pressures. However, the range of temperatures may be different from those listed where the reaction is carried out at other than atmospheric pressure. The reaction may be carried out for a period of time within the range of about 1 hour to about 8 hours, preferably, within the range of about 2 hours to about 6 hours.

In some aspects of the present application, the reaction product of (i) and (ii) may be used in combination with a fuel soluble carrier. Such carriers may be of various types, such as liquids or solids, e.g., waxes. Examples of liquid carriers include, but are not limited to, mineral oil and oxygenates, such as liquid polyalkoxylated ethers (also known as polyalkylene glycols or polyalkylene ethers), liquid polyalkoxylated phenols, liquid polyalkoxylated esters, liquid polyalkoxylated amines, and mixtures thereof. Examples of the oxygenate carriers may be found in U.S. Pat. No. 5,752,989, issued May 19, 1998 to Henly et. al., the description of which carriers is herein incorporated by reference in its entirety. Additional examples of oxygenate carriers include alkyl-substituted aryl polyalkoxylates described in U.S. Patent Publication No. 2003/0131527, published Jul. 17, 2003 to Colucci et. al., the description of which is herein incorporated by reference in its entirety.

In other aspects, the reaction product of (i) and (ii) may not contain a carrier. For example, some additive compositions of the present disclosure may not contain mineral oil or oxygenates, such as those oxygenates described above.

One or more additional optional compounds may be present in the fuel compositions of the disclosed embodiments. For example, the fuels may contain conventional quantities of cetane improvers, corrosion inhibitors, cold flow improvers (CFPP additive), pour point depressants, solvents, demulsifiers, lubricity additives, friction modifiers, amine stabilizers, combustion improvers, dispersants, antioxidants, heat stabilizers, conductivity improvers, metal deactivators, marker dyes, organic nitrate ignition accelerators, cyclomatic manganese tricarbonyl compounds, and the like. In some aspects, the compositions described herein may contain about 10 weight percent or less, or in other aspects, about 5 weight percent or less, based on the total weight of the additive concentrate, of one or more of the above additives. Similarly, the fuels may contain suitable amounts of conventional fuel blending components such as methanol, ethanol, dialkyl ethers, and the like.

In some aspects of the disclosed embodiments, organic nitrate ignition accelerators that include aliphatic or cycloaliphatic nitrates in which the aliphatic or cycloaliphatic group is saturated, and that contain up to about 12 carbons may be used. Examples of organic nitrate ignition accelerators that may be used are methyl nitrate, ethyl nitrate, propyl nitrate, isopropyl nitrate, allyl nitrate, butyl nitrate, isobutyl nitrate, sec-butyl nitrate, tert-butyl nitrate, amyl nitrate, isoamyl nitrate, 2-amyl nitrate, 3-amyl nitrate, hexyl nitrate, heptyl nitrate, 2-heptyl nitrate, octyl nitrate, isooctyl nitrate, 2-ethylhexyl nitrate, nonyl nitrate, decyl nitrate, undecyl nitrate, dodecyl nitrate, cyclopentyl nitrate, cyclohexyl nitrate, methylcyclohexyl nitrate, cyclododecyl nitrate, 2-ethoxyethyl nitrate, 2-(2-ethoxyethoxyl)ethyl nitrate, tetrahydrofuranyl nitrate, and the like. Mixtures of such materials may also be used.

Examples of suitable optional metal deactivators useful in the compositions of the present application are disclosed in U.S. Pat. No. 4,482,357 issued Nov. 13, 1984, the disclosure of which is herein incorporated by reference in its entirety. Such metal deactivators include, for example, salicylidene-o-aminophenol, disalicylidene ethylenediamine, disalicylidene propylenediamine, and N,N′-disalicylidene-1,2-diaminopropane.

Other metal deactivators that may be used, include, but are not limited to derivatives of benzotriazoles such as tolyltriazole; N,N-bis(heptyl)-ar-methyl-1H-benzotriazole-1-methanamine; N,N-bis(nonyl)-ar-methyl-1H-benzo-triazole-1-methanamine; N,N-bis(decyl)-ar-methyl-1H-benzotriazole-1-methanamine; N,N-bis(undecyl)-ar-methyl-1H-benzotriazole-1-methanamine; N,N-bis(dodecyl)-ar-methyl-1H-benzotriazole-1-methanamine; N,N-bis(2-ethylhexyl)-ar-methyl-1H-benzotriazole-1-methanamine and mixtures thereof. In one embodiment the metal deactivator is selected from N,N-bis(2-ethylhexyl)-ar-methyl-1H-benzotriazole; 1-methanamine; 1,2,4-triazoles; benzimidazoles; 2-alkyldithiobenzimidazoles; 2-alkyldithiobenzothiazoles; 2-(N,N-dialkyldithiocarbamoyl)benzothiazoles; 2,5-bis(alkyl-dithio)-1,3,4-thiadiazoles such as 2,5-bis(tert-octyldithio)-1,3,4-thiadiazole; 2,5-bis(tert-nonyldithio)-1,3,4-thiadiazole; 2,5-bis(tert-decyldithio)-1,3,4-thiadiazole; 2,5-bis(tert-undecyldithio)-1,3,4-thiadiazole; 2,5-bis(tert-dodecyldithio)-1,3,4-thiadiazole; 2,5-bis(tert-tridecyldithio)-1,3,4-thiadiazole; 2,5-bis(tert-tetradecyldithio)-1,3,4-thiadiazole; 2,5-bis(tert-pentadecyldithio)-1,3,4-thiadiazole; 2,5-bis(tert-hexadecyldithio)-1,3,4-thiadiazole; 2,5-bis(tert-heptadecyldithio)-1,3,4-thiadiazole; 2,5-bis(tert-octadecyldithio)-1,3,4-thiadiazole; 2,5-bis(tert-nonadecyldithio)-1,3,4-thiadiazole; 2,5-bis(tert-eicosyldithio)-1,3,4-thiadiazole; and mixtures thereof; 2,5-bis(N,N-dialkyldithiocarbamoyl)-1,3,4-thiadiazoles; 2-alkyldithio-5-mercapto thiadiazoles; and the like. The metal deactivator may be present in the range of about 0% to about 90%, and in one embodiment about 0.0005% to about 50% and in another embodiment about 0.0025% to about 30% of the fuel additive. A suitable amount of metal deactivator may range from about 5 ppm by weight to about 15 ppm by weight of a total weight of a fuel composition.

Suitable optional cyclomatic manganese tricarbonyl compounds which may be employed in the compositions of the present application include, for example, cyclopentadienyl manganese tricarbonyl, methylcyclopentadienyl manganese tricarbonyl, indenyl manganese tricarbonyl, and ethylcyclopentadienyl manganese tricarbonyl. Yet other examples of suitable cyclomatic manganese tricarbonyl compounds are disclosed in U.S. Pat. No. 5,575,823, issued Nov. 19, 1996, and U.S. Pat. No. 3,015,668, issued Jan. 2, 1962, both of which disclosures are herein incorporated by reference in their entirety.

Other commercially available additives may be used in combination with additive components. Such additive include but are not limited to other succinimides, Mannich base compounds, quaternary ammonium compounds, bis-aminotriazole compounds, polyether amine compounds, polyhydrocarbyl amine compounds, and other amino-guanidine reaction products.

When formulating the fuel compositions of this application, the reaction product of (i) and (ii) may be employed in amounts sufficient to reduce or inhibit deposit formation in a fuel system or combustion chamber of an engine and/or crankcase. In some aspects, the fuels may contain minor amounts of the above described additive composition that controls or reduces the formation of engine deposits, for example injector deposits in diesel engines. For example, the diesel fuels of this application may contain, on an active ingredient basis, a total amount of the reaction product of (i) and (ii) in the range of about 25 mg to about 300 mg of additive composition per Kg of fuel, such as in the range of about 30 mg to about 200 mg of per Kg of fuel or in the range of from about 40 mg to about 150 mg of the additive composition per Kg of fuel. The active ingredient basis excludes the weight of unreacted components associated with and remaining in additive composition, and solvent(s), if any, used in the manufacture of the additive composition either during or after its formation but before addition of a carrier, if a carrier is employed.

The additive compositions of the present application, including the reaction product of (i) and (ii) described above, and optional additives used in formulating the fuels of this invention may be blended into the base diesel fuel individually or in various sub-combinations. In some embodiments, the additive components of the present application may be blended into the diesel fuel concurrently using an additive concentrate, as this takes advantage of the mutual compatibility and convenience afforded by the combination of ingredients when in the form of an additive concentrate. Also, use of a concentrate may reduce blending time and lessen the possibility of blending errors.

The fuels of the present application may be applicable to the operation of gasoline and diesel engines. The engine include both stationary engines (e.g., engines used in electrical power generation installations, in pumping stations, etc.) and ambulatory engines (e.g., engines used as prime movers in automobiles, trucks, road-grading equipment, military vehicles, etc.). For example, the fuels may include any and all middle distillate fuels, gasoline, diesel fuels, biorenewable fuels, biodiesel fuel, gas-to-liquid (GTL) fuels, jet fuel, alcohols, ethers, kerosene, low sulfur fuels, synthetic fuels, such as Fischer-Tropsch fuels, liquid petroleum gas, bunker oils, coal to liquid (CTL) fuels, biomass to liquid (BTL) fuels, high asphaltene fuels, fuels derived from coal (natural, cleaned, and petcoke), genetically engineered biofuels and crops and extracts therefrom, and natural gas. “Biorenewable fuels” as used herein is understood to mean any fuel which is derived from resources other than petroleum. Such resources include, but are not limited to, corn, maize, soybeans and other crops; grasses, such as switchgrass, miscanthus, and hybrid grasses; algae, seaweed, vegetable oils; natural fats; and mixtures thereof. In an aspect, the biorenewable fuel can comprise monohydroxy alcohols, such as those comprising from 1 to about 5 carbon atoms. Non-limiting examples of suitable monohydroxy alcohols include methanol, ethanol, propanol, n-butanol, isobutanol, t-butyl alcohol, amyl alcohol, and isoamyl alcohol.

Diesel fuels that may be used include low sulfur diesel fuels and ultra low sulfur diesel fuels. A “low sulfur” diesel fuel means a fuel having a sulfur content of 50 ppm by weight or less based on a total weight of the fuel. An “ultra low sulfur” diesel fuel (ULSD) means a fuel having a sulfur content of 15 ppm by weight or less based on a total weight of the fuel. In another embodiment, the diesel fuels are substantially devoid of biodiesel fuel components.

Accordingly, aspects of the present application are directed to methods for reducing the amount of injector deposits of engines having at least one combustion chamber and one or more direct fuel injectors in fluid connection with the combustion chamber.

In some aspects, the methods comprise injecting a hydrocarbon-based compression ignition fuel comprising the additive composition of the present disclosure through the injectors of the diesel engine into the combustion chamber, and igniting the compression ignition fuel. In some aspects, the method may also comprise mixing into the diesel fuel at least one of the optional additional ingredients described above.

The fuel compositions described herein are suitable for both direct and indirect injected diesel engines. The direct injected diesel engines include high pressure common rail direct injected engines.

In one embodiment, the diesel fuels of the present application may be essentially free, such as devoid, of conventional succinimide dispersant compounds. In another embodiment, the fuel is essentially free of quaternary ammonium salts of a hydrocarbyl succinimide or quaternary ammonium salts of a hydrocarbyl Mannich. The term “essentially free” is defined for purposes of this application to be concentrations having substantially no measurable effect on injector cleanliness or deposit formation.

### EXAMPLES

The following examples are illustrative of exemplary embodiments of the disclosure. In these examples as well as elsewhere in this application, all parts and percentages are by weight unless otherwise indicated. It is intended that these examples are being presented for the purpose of illustration only and are not intended to limit the scope of the invention disclosed herein.

### Comparative Example 1

An additive was produced from the reaction of a 950 number average molecular weight polyisobutylene succinic anhydride (PIBSA) with tetraethylenepentamine (TEPA) in a molar ratio of PIBSA/TEPA=1:1. PIBSA (551 grams) was diluted in 200 grams of aromatic 150 solvent under a nitrogen atmosphere. The mixture was heated to 115° C. TEPA was then added through an addition funnel. The addition funnel was rinsed with additional 50 grams of solvent aromatic 150 solvent. The mixture was heated to 180° C. for about 2 hours under a slow nitrogen sweep. Water was collected in a Dean-Stark trap. The reaction mixture was further vacuum stripped to remove volatiles to give a brownish oil product. Residual TEPA was about 5.89 wt. % in the reaction product based on the active material in the reaction product as determined by gas chromatograph.

### Comparative Example 2

An additive was made similar to that of Comparative Example 1, except that the molar ratio of PIBSA/TEPA was 1.6:1.

### Comparative Example 3

An additive was made similar to that of Comparative Example 2, except that the except that the reaction was mixture was heated at 100° C. for 3 hours.

### Comparative Example 4

An additive was made similar to that of Comparative Example 1, except that the molar ratio of PIBSA/TEPA was 1.4:1.

### Comparative Example 5

An additive was made similar to that of Comparative Example 1, except that 550 number average molecular weight polyisobutylene succinic anhydride (PIBSA) was used instead of the 950 number average molecular weight PIBSA and the molar ratio of PIBSA/TEPA was 1.5:1.

### Comparative Example 6

An additive was made similar to that of Inventive Example 5, except that 750 number average molecular weight polyisobutylene succinic anhydride (PIBSA) was used instead of the 550 number average molecular weight PIBSA and tri-ethylene tetramine (TETA) was used in place of TEPA.

### Comparative Example 7

An additive was made similar to that of Comparative Example 1, except that 750 number average molecular weight polyisobutylene succinic anhydride (PIBSA) was used instead of the 950 number average molecular weight PIBSA. Residual TEPA was about 7.72 wt. % in the reaction product based on the active material in the reaction product as determined by gas chromatograph.

### Inventive Example 8

An additive was made similar to that of Comparative Example 1, except that 750 number average molecular weight polyisobutylene succinic anhydride (PIBSA) was used instead of the 950 number average molecular weight PIBSA and the molar ratio of PIBSA/TEPA was 1.6:1.

### Inventive Example 9

An additive was made similar to that of Comparative Example 7, except that the molar ratio of PIBSA/TEPA was 1.3:1. Residual TEPA was about 2.16 wt. % in the reaction product based on the active material in the reaction product as determined by gas chromatograph.

### Inventive Example 10

An additive was made similar to that of Inventive Example 8, except that the molar ratio of PIBSA/TEPA was 1.5:1. Residual TEPA was about 1.02 wt. % in the reaction product based on the active material in the reaction product as determined by gas chromatograph.

### Inventive Example 11

An additive was made similar to that of Inventive Example 10, except that the reaction mixture was heated at 110° C. for 1.5 hours to give a product as a brownish oil. Residual TEPA was about 2.05 wt. % based on the active material in the reaction product as determined by gas chromatograph.

For comparison purposes, the percent flow remaining was determined in the XUD-9 engine test as shown in Table 2. The XUD-9 test (CEC F-23-01 XUD-9 method) method is designed to evaluate the capability of a fuel to control the formation of deposits on the injector nozzles of an Indirect Injection diesel engine. All XUD-9 tests were run in DF-790 reference fuel. Results of tests run according to the XUD-9 test method are expressed in terms of the percentage airflow loss at various injector needle lift points. Airflow measurements are accomplished with an airflow rig complying with ISO 4010.

Prior to conducting the test, the injector nozzles are cleaned and checked for airflow at 0.05, 0.1, 0.2, 0.3 and 0.4 mm lift. Nozzles are discarded if the airflow is outside of the range 250 ml/min to 320 ml/min at 0.1 mm lift. The nozzles are assembled into the injector bodies and the opening pressures set to 115±5 bar. A slave set of injectors is also fitted to the engine. The previous test fuel is drained from the system. The engine is run for 25 minutes in order to flush through the fuel system. During this time all the spill-off fuel is discarded and not returned. The engine is then set to test speed and load and all specified parameters checked and adjusted to the test specification. The slave injectors are then replaced with the test units. Air flow is measured before and after the test. An average of 4 injector flows at 0.1 mm lift is used to calculate the percent of fouling. The degree of flow remaining=100−percent of fouling. The results are shown in the following table.

TABLE 1

| | | 0.1 mm Lift | |
|---|---|---|---|
| | Treat rate (ppm | Flow remaining | Residual Amine |
| Fuel Additive | by weight) | (%) | (wt. %) |
| Base fuel | NA | 23 | — |
| Additive of | 50 | 46 | 5.89 |
| Comparative Ex. 1 | | | |
| Additive of | 50 | 33 | Below detectible |
| Comparative Ex. 2 | | | limits |
| Additive of | 50 | 28 | |
| Comparative Ex. 3 | | | |
| Additive of | 50 | 24 | |
| Comparative Ex. 5 | | | |
| Additive of | 50 | 34 | |
| Comparative Ex. 6 | | | |
| Inventive Ex. 8 | 50 | 43 | Below detectible |
| | | | limits |
| Inventive Ex. 9 | 50 | 58 | 2.16 |
| Inventive Ex. 10 | 50 | 60 | 1.02 |
| Inventive Ex. 11 | 50 | 65 | 2.05 |

As shown in Table 1, the Inventive Examples 8-11 have significantly better flow properties than the higher or lower molecular weight materials and materials made with ratios of less than about 1.3:1 or greater than about 1.6:1 at the same treat rates. As shown in the above table Inventive Example 8 had better XUD-9 performance than the higher molecular weight product (Comparative Example 2) with the same PIBSA/TEPA molar ratio. The Inventive Examples 8-11 also contained significantly lower residual amine content in the reaction product than Comparative Example 1. Accordingly, the inventive examples are unexpectedly more effective than the comparative examples in providing improvement in the XUD-9 test in diesel fuel.

### Diesel Engine Test Protocol

A DW10 test that was developed by Coordinating European Council (CEC) was used to demonstrate the propensity of fuels to provoke fuel injector fouling and was also used to demonstrate the ability of certain fuel additives to prevent or control these deposits. Additive evaluations used the protocol of CEC F-98-08 for direct injection, common rail diesel engine nozzle coking tests. An engine dynamometer test stand was used for the installation of the Peugeot DW10 diesel engine for running the injector coking tests. The engine was a 2.0 liter engine having four cylinders. Each combustion chamber had four valves and the fuel injectors were DI piezo injectors have a Euro V classification.

The core protocol procedure consisted of running the engine through a cycle for 8-hours and allowing the engine to soak (engine off) for a prescribed amount of time. The foregoing sequence was repeated four times. At the end of each hour, a power measurement was taken of the engine while the engine was operating at rated conditions. The injector fouling propensity of the fuel was characterized by a difference in observed rated power between the beginning and the end of the test cycle.

Test preparation involved flushing the previous test's fuel from the engine prior to removing the injectors. The test injectors were inspected, cleaned, and reinstalled in the engine. If new injectors were selected, the new injectors were put through a 16-hour break-in cycle. Next, the engine was started using the desired test cycle program. Once the engine was warmed up, power was measured at 4000 RPM and full load to check for full power restoration after cleaning the injectors. If the power measurements were within specification, the test cycle was initiated. The following Table 2 provides a representation of the DW10 coking cycle that was used to evaluate the fuel additives according to the disclosure.

TABLE 2
One hour representation of DW10 coking cycle.

| | Duration | Engine speed | Load | | Boost air after |
|---|---|---|---|---|---|
| Step | (minutes) | (rpm) | (%) | Torque (Nm) | Intercooler (° C.) |
| 1 | 2 | 1750 | 20 | 62 | 45 |
| 2 | 7 | 3000 | 60 | 173 | 50 |
| 3 | 2 | 1750 | 20 | 62 | 45 |
| 4 | 7 | 3500 | 80 | 212 | 50 |
| 5 | 2 | 1750 | 20 | 62 | 45 |
| 6 | 10 | 4000 | 100 | * | 50 |
| 7 | 2 | 1250 | 10 | 25 | 43 |
| 8 | 7 | 3000 | 100 | * | 50 |
| 9 | 2 | 1250 | 10 | 25 | 43 |
| 10 | 10 | 2000 | 100 | * | 50 |
| 11 | 2 | 1250 | 10 | 25 | 43 |
| 12 | 7 | 4000 | 100 | * | 50 |

Various fuel additives were tested using the foregoing engine test procedure in an ultra low sulfur diesel fuel containing zinc neodecanoate, 2-ethylhexyl nitrate, and a fatty acid ester friction modifier (base fuel). A “dirty-up” phase consisting of base fuel only with no additive was initiated, followed by a “clean-up” phase consisting of the base fuel plus additive(s). All runs were made with 8 hour dirty-up and 8 hour clean-up unless indicated otherwise. The percent power recovery was calculated using the power measurement at end of the “dirty-up” phase and the power measurement at end of the “clean-up” phase. The percent power recovery was determined by the following formula

Percent Power recovery=(DU−CU)/DU×100

wherein DU is a percent power loss at the end of a dirty-up phase without the additive, CU is the percent power loss at the end of a clean-up phase with the fuel additive, and power is measured according to CEC F-98-08 DW10 test. Table 3 provides the DW10 test results for use of the additives in a PC10 fuel and Table 4 provides the DW10 results for the additives in a biodiesel fuel.

TABLE 3

| | Treat rate | DU % | CU % | % power | % Efficiency |
|---|---|---|---|---|---|
| | (ppm by | Power | Power | Recovery | (% PU/ |
| Additive | weight) | Change | Change | (% PU) | 100 ppm/hr) |
| Comparative | 180 | −4.71 | −4.46 | 5 | 0.2 |
| Ex. 1¹ | | | | | |
| Comparative | 85 | −5.7 | −5.4 | 5 | 0.8 |
| Ex. 2 | | | | | |
| Inventive Ex. 9 | 75 | −6.08 | −3.36 | 45 | 7.5 |
| Inventive Ex. 9 | 85 | −5.12 | −2.57 | 50 | 7.3 |
| Inventive | 85 | −5.89 | −3.26 | 45 | 6.6 |
| Ex. 10 | | | | | |

¹DU = 16 hours and CU = 16 hours

TABLE 4

| | Treat rate | DU % | CU % | % power | % Efficiency |
|---|---|---|---|---|---|
| | (ppm by | Power | Power | Recovery | (% PU/ |
| Additive | weight) | Change | Change | (% PU) | 100 ppm/hr) |
| Comparative | 150 | −4.89 | −4.47 | 9 | 0.7 |
| Ex. 1 | | | | | |
| Inventive Ex. 9 | 150 | −5.13 | −2.91 | 43 | 3.6 |

As shown by the results in the above tables, the inventive examples 9 and 10 provided unexpectedly superior power recovery in both low sulfur diesel fuel and biodiesel fuel compared to the higher molecular weight additives at similar treat rates.

Demulsibility tests were also conducted on the comparative and inventive examples as shown in Table 5 to determine how readily the additive composition provided separation between water and fuel. Demulsibility was conducted according to ASTM D-1094. The fuel was an ultra low sulfur diesel fuel having a buffered pH of 7. The active treat rate of the additive was 225 ppm and the fuel contained 10 ppm by weight of a commercial polyglycol demulsifiers.

TABLE 5

| Additive | Full water recovery time | 1b time |
|---|---|---|
| Base ULSD | 55 sec | 1 min |
| Comparative Ex. 1 | Not achieved | n/a |
| Comparative Ex. 4 | Not achieved | n/a |
| Comparative Ex. 7 | Not achieved | n/a |
| Inventive Ex. 9 | 8 min 40 sec | 13 min 15 sec |
| Inventive Ex. 10 | 6 min | 8 min |

As shown in Table 5, the inventive reaction products of Inventive Examples 9-10 had unexpectedly superior demulsibility compared to the higher molecular weight reaction products of Comparative Examples 1 and 4.

It is noted that, as used in this specification and the appended claims, the singular forms “a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A method of improving injector performance of a fuel injected engine comprising operating the engine on a fuel composition comprising a major amount of fuel and from about 25 to about 300 ppm by weight based on a total weight of the fuel composition of a reaction product derived from (i) a hydrocarbyl substituted dicarboxylic acid or anhydride, wherein the hydrocarbyl substituent has a number average molecular weight ranging from about 600 to about 800 and (ii) a polyamine comprising a compound of the formula H₂N—((CHR¹—(CH₂)ₙ—NH)ₘ—H, wherein R¹ is hydrogen, n is 1 and m is 4, wherein a molar ratio of (i) reacted with (ii) ranges from about 1.3:1 to about 1.6:1, and wherein the reaction product, as made without removing unreacted polyamine from the reaction product, contains no more than 2.5 wt. % unreacted polyamine based on active material in the reaction product, wherein improved injector performance comprises recovering at least 30% of the power lost during a dirty up phase of a CEC F-98-08 test conducted on the fuel in the absence of the reaction product.

2. (canceled)

3. The method of claim 1, wherein the polyamine comprises tetraethylene pentamine.

4. The method of claim 1, wherein a molar ratio of (i) reacted with (ii) ranges from about 1.3:1 to about 1.5:1.

5. The method of claim 1, wherein the amount of reaction product in the fuel ranges from about 40 to about 150 ppm by weight based on a total weight of fuel.

6. The method of claim 1, wherein the fuel comprises a low sulfur diesel fuel.

7. The method of claim 6, wherein the low sulfur diesel is substantially devoid of biodiesel fuel components.

8. A method of restoring power to a diesel fuel injected engine after an engine dirty-up phase comprising combusting in the engine a diesel fuel composition comprising a major amount of fuel and from about 25 to about 300 ppm by weight based on a total weight of the fuel composition of a reaction product derived from (i) a hydrocarbyl substituted dicarboxylic acid or anhydride, wherein the hydrocarbyl substituent has a number average molecular weight ranging from about 600 to about 800 and (ii) a polyamine comprising a compound of the formula H₂N—((CHR¹—(CH₂)ₙ—NH)ₘ—H, wherein R¹ is hydrogen, n is 1 and m is 4, wherein a molar ratio of (i) reacted with (ii) ranges from about 1.3:1 to about 1.6:1, and wherein the reaction product, as made without removing unreacted polyamine from the reaction product, contains no more than 2.5 wt. % unreacted polyamine based on active material in the reaction product;
wherein the power restoration is measured by the following formula:
Percent Power recovery=(DU−CU)/DU×100
wherein DU is a percent power loss at the end of a dirty-up phase without the reaction product, CU is the percent power loss at the end of a clean-up phase with the reaction product, and said power restoration is greater than 30%.

9. The method of claim 8, wherein the power restoration is measured as percent power recovery relative to the power before the dirty up phase and said power restoration is greater than 40%.

10. The method of claim 1, wherein the engine comprises a direct fuel injected diesel engine.

11. A method of operating a fuel injected diesel engine to improve power recovery of the engine comprising combusting in the engine a fuel composition comprising a major amount of fuel and from about 25 to about 300 ppm by weight based on a total weight of the fuel of an additive comprising:
a reaction product derived from (i) a hydrocarbyl substituted dicarboxylic acid or anhydride, wherein the hydrocarbyl substituent has a number average molecular weight ranging from about 600 to about 800 and (ii) tetraethylene pentamine (TEPA) wherein a molar ratio of (i) reacted with (ii) ranges from about 1.3:1 to about 1.6:1, and wherein the reaction product as made without removing unreacted polyamine from the reaction product, contains no more than 2.5 wt. % unreacted polyamine based on active material in the reaction product, and wherein at least 30% of power lost during a dirty up phase of a CEC F-98-08 test conducted on the fuel composition in the absence of the reaction product is recovered.

12. The method of claim 11, wherein a molar ratio of (i) reacted with (ii) ranges from about 1.3:1 to about 1.5:1.

13. The method of claim 11, wherein the amount of additive in the fuel ranges from about 40 to about 100 ppm by weight based on a total weight of fuel.

14. The method of claim 11, wherein the fuel comprises a low sulfur diesel fuel.

15. The method of claim 14, wherein the low sulfur diesel is substantially devoid of biodiesel fuel components.

16. A method of improving the demulsibility of an additive containing diesel fuel composition comprising combining a major amount of diesel fuel with from about 25 to about 300 ppm by weight based on a total weight of the fuel of a reaction product having power improving properties derived from (i) a hydrocarbyl substituted dicarboxylic acid or anhydride, wherein the hydrocarbyl substituent has a number average molecular weight ranging from about 600 to about 800 and (ii) a polyamine comprising a compound of the formula H₂N—((CHR¹—(CH₂)ₙ—NH)ₘ—H, wherein R¹ is hydrogen, n is 1 and m is 4, wherein a molar ratio of (i) reacted with (ii) ranges from about 1.3:1 to about 1.6:1 molar, and wherein the reaction product, as made without removing unreacted polyamine from the reaction product, contains no more than 2.5 wt. % unreacted polyamine based on active material in the reaction product.

17. The method of claim 16, wherein a molar ratio of (i) reacted with (ii) ranges from about 1.3:1 to about 1.5:1.
